(19) United States
(12) Patent Application Publication
(10) Pub. No.: US 2008/0117560 A1
(43) Pub. Date: May 22, 2008

(54) Minimal capacitance adjustable capacitor

(75) Inventor: James P. Finnigan, Saratoga, CA (US)

Correspondence Address: Varian Inc.;Legal Department, 3120 Hansen Way D-102, Palo Alto, CA, 94304, US

(73) Assignee: Varian, Inc.

(21) Appl. No.: 11/603,552

(22) Filed: Nov. 22, 2006

(51) Int. Cl. H01G 5/00

(52) U.S. Cl. 361/289

(57) ABSTRACT

A pair of conductors, spaced apart on the same first surface, form stators of a pair of series connected capacitors in combination with a floating moveable conductor disposed on a parallel second surface with a dielectric in the space between first and second surfaces. The floating conductor has sufficient area to occupy the projection of the stators on the second surface. As the moveable conductor is displaced toward one of the stators and away form the other, the capacitance diminishes until the series circuit is interrupted.

### RELATED APPLICATION

This application is related to the application entitled “Multi-Functional NMR Probe” by Albert P. Zens and James P. Finnigan, which application is being filed on the same date as the present application and is assigned to the assignee of the present application.

### BACKGROUND OF THE INVENTION

The present work is directed to variable capacitor structure and usage particularly optimized for achieving a capacitance value approaching zero at one extreme.

Capacitance coupling between RF circuits comprises a reactive impedance inversely proportional to the product of frequency and capacitance. This reactive impedance component exhibits a frequency dependence, the reactance approaches infinity as the capacitance approaches zero. In situations where a resistive or inductive component can be neglected, the variable coupling capacitor has the properties of an RF switch, imperfect only insofar as determined by the minimum achievable capacitance. Reference to such switch is understood most simply in this context as a functional 2 state device, ignoring intermediate values of capacitance. In other applications, the continuous range of capacitance values is desirable for traditional functions such as the tuning and matching of a resonant circuit to a transmission line.

Specialization in the application for circuit components is related to the specialized environment for these circuits. Of particular interest herein is the NMR instrument, which imposes constraints on materials for both magnetic properties and for certain chemical properties. Intense magnetic fields of carefully controlled spatial distribution characterize magnetic resonance apparatus requiring components of the instrument to comprise materials that will not compromise that controlled spatial distribution. Depending upon the proximity of the component to the measurement volume, the magnetic susceptibility of the material of the component can be an issue for consideration. The chemical properties of the material may also be critical if the material contains an isotope exhibiting nuclear magnetic resonance in the magnetic fields and frequencies prevailing in the instrument. A prior art NMR probe utilizing adjustable capacitance in an axial geometry close to the NMR measurement volume and realizing adjustment through axial displacement is known and described in U.S. Pat. No. 7,064,549 commonly assigned herewith.

### SUMMARY OF THE INVENTION

Although the discussion herein is conducted in terms of a cylindrical geometry, no such limitation is intended, and the apparatus of this work may be as easily realized in alternate form.

An adjustable capacitor exhibiting minimal capacitance value at one extreme of adjustment, provides an RF impedance approaching infinity as the minimum capacitance approaches zero, and thereby furnishes the basis for an RF switch when the other extreme furnishes a capacitance value to yield an acceptable dynamic range of impedance. It is quantifiable in relative terms that the minimum capacitance value is very small compared to other relevant capacitances of the circuit in which this RF switch is deployed and inclusive of the relevant parasitic capacitances. This component, suitable for general application and a particular application to coupling/decoupling resonant sub-circuits, is implemented with particular attention to use in NMR probe circuits.

Coaxial silica glass (a preferred class of material) tubes are selected of mutual dimensional tolerance to support at least a slip fit therebetween. This option for materials presents an excellent choice for application in the environment of an NMR instrument and is equally appropriate for general application. For ease of description only, consider an outer tube to support a pair of conductive bands, each band having a selected azimuthal extent and spaced axially apart by an amount such that the capacitance between these conductors is can be neglected in comparison with other capacitances. These conductive bands each comprise a stator forming a pair of series connected capacitances in conjunction with a floating conductor supported by the inner tube on a surface thereof that is (obviously) non-adjacent to the conductors supported by the outer tube (for slip fit coaxial tubes). The outer surface is preferred for support of the stators because the inner surface presents additional complication in electrical access to these stators. For the stators on the outer surface of the outer tube, either inner or outer surface of the inner tube may be selected to support the floating conductor which may be conveniently regarded as a moveable capacitor plate for both capacitors. The choice of inner or outer surface of this tube for conductor support is a choice of dielectric thickness (and possibly of disparate dielectric constants). The axial extent of the floating conductor is sufficient to completely overlap the two stator plates in one position of the device, forming two series connected capacitors. Relative displacement of the (assumed moveable) floating conductor progressively decreases the capacitance of one of the series capacitances and continued relative displacement breaks the series connection of the two capacitors. Further relative displacement may be desirable to reduce parasitic capacitance.

It will be understood that reference herein to the present “capacitor unit” encompasses the integral physical combination of a fixed capacitance in series with a variable capacitance and the termination of the series connection beyond the geometrical position for the minimum value of the variable sub-component. In this work, the reference to a “capacitor” will be understood, in appropriate context to refer to the capacitor unit of fixed and variable sub-components.

Various embodiments are conveniently implemented to realize multiple capacitor units in ganged relationships and/or switch selective relationships.

Silica glass materials, e.g., quartz or sapphire, have no adverse effect in certain contexts such as NMR probes. These materials exhibit a low coefficient of static friction and such tubes are available with excellent dimensional tolerances and high finish to support a fit requiring rather little axial force to provide the relative displacement. This permits a wide choice of linear actuators for operation. In some applications, Teflon® may be a desirable material for one or both tubes.

### BRIEF DESCRIPTION OF THE DRAWINGS

FIG. 1a illustrates an exploded view of a preferred embodiment of the present work.

FIG. 1b is a section through the embodiment of FIG. 1.

FIG. 1c is the electrical description of the embodiment of FIGS. 1, 1a.

FIG. 2a is a variation of FIG. 2a to accommodate a selected pair of capacitor units.

FIG. 2b is the electrical description of FIG. 2a.

FIG. 3a illustrates a section through a prior art capacitor, typical of the subject.

FIG. 3b is the equivalent circuit for FIG. 3a.

FIG. 3c illustrates a section through the present adjustable capacitor.

FIG. 3d is the equivalent circuit for FIG. 3c.

FIG. 4a is an exploded view of a dual/ganged pair of adjustable capacitors.

FIG. 4b is the equivalent circuit for FIG. 4a.

FIG. 4e shows a simple ganging arrangement for two capacitors.

FIG. 5 is a circuit employed to compare the present work with prior art.

### DETAILED DESCRIPTION OF THE INVENTION

The present work will be described with the aid of exemplary drawings for which the same functional component will bear the same label in the several embodiments.

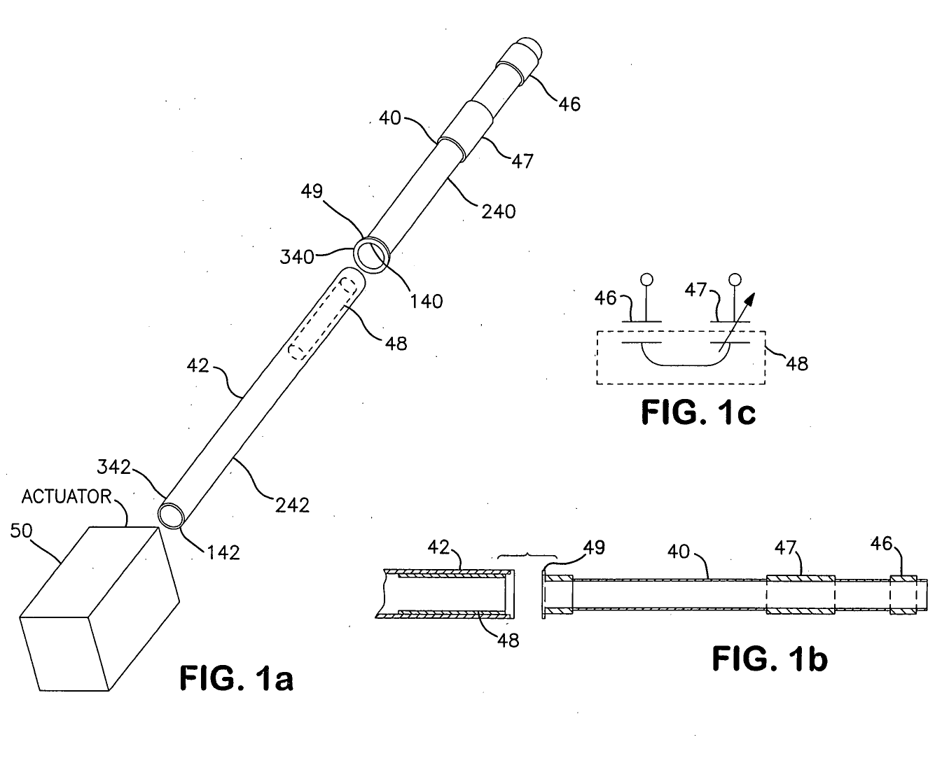

Turning now to FIG. 1a, there is illustrated an example of the present work embodied in an arrangement of outer and inner insulating tubes 40 and 42 (shown in exploded view), respectively disposed coaxially in sliding axial relationship. FIG. 1b is a section through a portion of FIG. 1a. Outer tube 40 is characterized by inner surface 140, outer surface 240 and wall thickness 340. Similarly, inner tube 42 has inner surface 142, outer surface 242 and wall thickness 342. The sliding relationship depends upon dimensional relationships, which are further characterized as consistent with at least a slip fit where such characterization is familiar to those of skill in the art. A selected pair of the four enumerated surfaces (excluding the pair 140- 242) are capable of supporting conducting surfaces implementing stators of the capacitor. Surfaces 240 and 142 are preferred for this purpose because these non-adjacent surfaces do not participate in the sliding relationship. The resulting capacitance values depend upon the wall thicknesses and dielectric constants of the materials of the tubular members 40 and 42. For the purposes of this work, the contribution from any finite air gap need not be discussed, but it is recognized that this air gap contributes to the overall dielectric properties of the capacitor.

In figure la, inner coaxial tube 42 is driven by actuator 50 and outer tube 40 is secured to the actuator housing by supporting collar and flange 49.

Insertion of moveable floating conducting surface 48 to fully face each of the spaced-apart conductors 46 and 47 results in a pair of series capacitances 48-46 and 48-47 as shown in the capacitor unit of FIG. 1c. The electrical design of the capacitance is elementary and specified by the desired maximum capacitance value. The minimum value requires that conductors 46 and 47 be spaced apart sufficiently to reduce the capacitance between them (with an air dielectric assumed) to an acceptably minute value. Given a finite thickness, t, for the stators and azimuthal length, L, the gap, g, separating conductors 46 and 47 is selected such that

g>>ε t L,

where ε is the dielectric constant, assumed here to be air. Conductors 46, 47 and 48 may be applied to their respective substrates by appropriate adhesives or by some suitable deposition process.

The description has been drawn to one example of the selection of surface pairs for conductor support. It is emphasized that non-adjacent surfaces are appropriate, and that the inner surface of the outer tube and outer surface of the inner tube are excluded as a pair of surfaces for conductor support, as this particular pair of adjacent surfaces would simply define a purely resistive path unless the component tubes define a controlled gap therebetween. The stators and floating conductor may be supported on the respective substrates through adhesives, or by a deposition process, or by an embedding procedure. Although the inner substrate is referenced herein as a tube, it may be a solid cylinder, with the floating conductor supported on the cylindrical surface, or embedded therein.

The selection of a particular pair of (non-adjacent) surfaces determines the intervening dielectric properties, especially of the tubular material and wall thickness, neither of which are necessarily identical for the present capacitor structure. In the embodiment of FIG. 1a, the capacitor stators occupy the outer wall/outer tube and inner wall/inner tube with the dielectric comprised of the sum of the wall thicknesses. In such case, there remains a finite air gap defined by the degree of fit between the two tubes. In high power applications that gap can be the site of electrical breakdown due to the lower dielectric strength of air. This can (in some applications) be alleviated by the application of a thin film of an appropriate dielectric grease. Note that a different selection of non adjacent surfaces is available; for example, the outer surface/outer tube with the outer surface of the inner tube is a choice that offers a degree of freedom in choice of dielectric properties and thickness.

For the present work, silica glass is the preferred class of material. This includes quartz and sapphire and the like. Such material exhibits satisfactory dielectric properties and the relevant surfaces are susceptible to achieving a high finish and excellent dimensional tolerance to reach the desired degree of fit. The coefficients of static and dynamic friction, magnetic susceptibility and (for NMR usage) freedom from ¹H and ¹⁹F contaminant are excellent desiderata and the coincidence of excellence for each of these properties is gratifying.

A low coefficient of friction permits utility of a wide range of actuator designs. A piston 52 transmits the force realized in actuator 50 to axially displace the (exemplary) inner tube 42. A common form of actuator is realized in a captive nut and threaded shaft where the captive nut is fixed in relation to the movable member, such as tube 42, and the threaded shaft is fixed in relation to the static member, such as tube 40. An example of this common form of rotary to axial actuator suitable for the present application, is commercially available from Maxon Precision Motors, Inc, Fall River, Mass.

In many applications, and particularly for the case of an NMR probe, a piezo actuator is desirable to produce axial displacement such as is required in the present work. Such piezo actuators are also commercially available. One example is the Squiggle® type actuator available from NewScale Technologies, Victor, N.Y. Additionally, such actuators are further described in U.S. Pat. No. 7,061,745.

Elaboration of the embodiment of FIG. 1a in variations will be discussed and shown with similar structure bearing the same label. The actuator assembly 50 can be assumed to be a component of each embodiment.

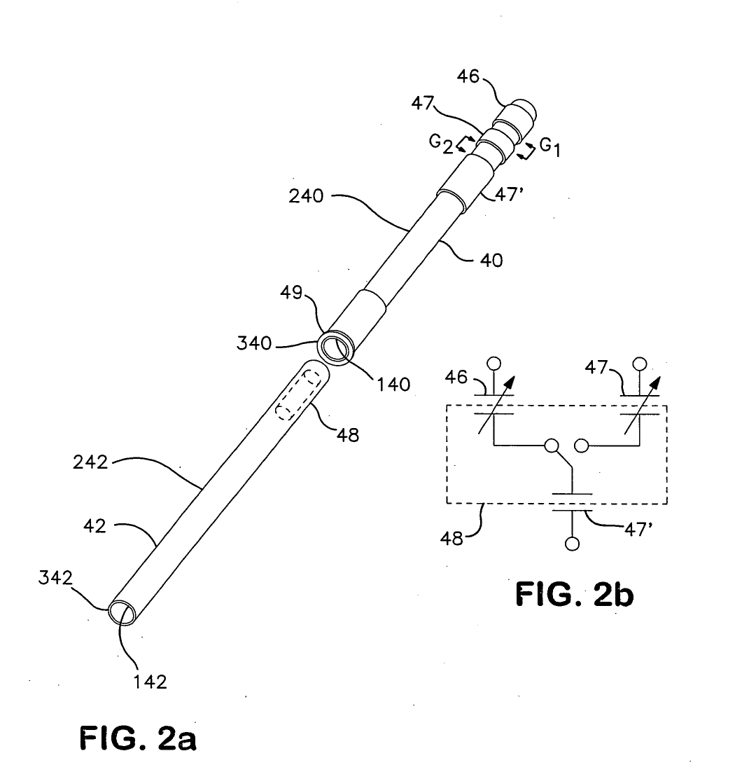

FIG. 2a is another embodiment wherein three stators 46, 47 and 47′ together with floating conductor 48, form (at successive displacements of conductor 48) capacitor pairs 46, 48 and 47, 48; followed by 47, 48 and 47′, 48. This is equivalent to a selector mechanism for selection of either pair of stators forming a pair of capacitor units. FIG. 2b is a diagrammatic equivalent of FIG. 2a for a particular choice of relative dimensions for the gaps G1 and G2 between stator pairs and the length of the floating conductor 48. Other functional variations of FIG. 2a will be discussed below.

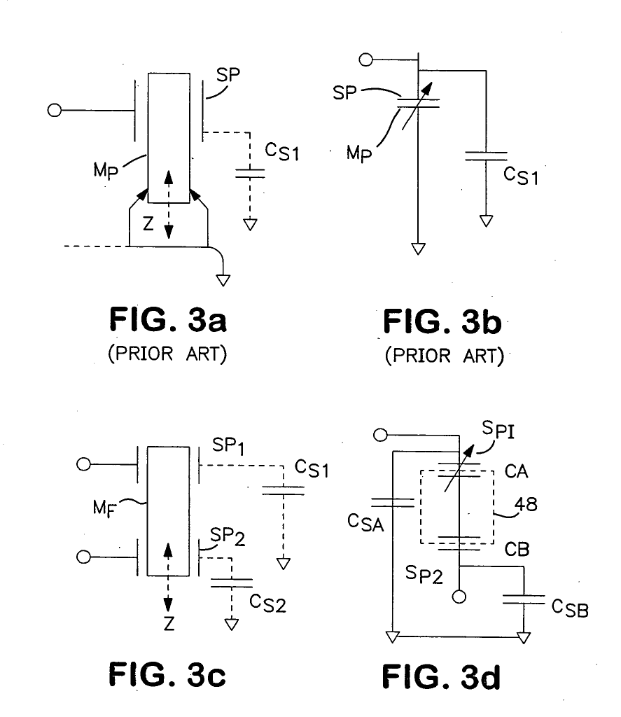

The advantages of the present work are best explained with the aid of FIGS. 3a,b (prior art) in comparison with FIGS. 3c,d (this work). FIGS. 3a,c are treated graphically as sections through a tubular embodiment as consistent with the foregoing. In FIG. 3a, a prior art capacitor comprises a stator Sₚ spaced apart from a conductor Mₚ connected to ground (or the equivalent). Mₚ is usually adapted for mechanical displacement along the axis, z, of the device as suggested by the dotted lines and the conceptual spring contacts. The stator Sₚ and the movable conductor forms a maximum designed capacitance C⁺ determined by the relevant dimensions and the character of the medium filling the space therebetween. Additionally, the stator Sₚ enjoys a capacitive relation to ground through stray capacitance Cₛ₁. In those applications where a very high capacitive impedance coupling is a major consideration, the combination of stray capacitance (essentially a fixed value) with the minimum adjustable value C⁻, produces a total capacitance as shown in FIG. 3b and given as defining the capacity range Cₘₐₓ to Cₘᵢₙ as

Cₘₐₓ=C⁺+Cₛ₁

Cₘᵢₙ=C⁻+Cₛ₁

### Assuming that Cₘᵢₙ=Cₛ₁ (a reasonable result), the minimum achievable capacitance is 2 Cₛ₁.

In FIG. 3c the capacitor unit of this work is presented for comparison with a representative prior art capacitor illustrated in FIG. 3a. Here, a floating conductor, M_{f}, (in its fully engaged position) forms a first capacitance CA with stator S₁ and at the same time, in series therewith, another capacitance CB with stator S₂. Each stator independently has respective capacitance to ground, in parallel with C_{A} and C_{B}, through stray capacitances CsA and CsB. The direct capacitive coupling between stators is small compared to their stray capacitance to ground, and can thus be neglected. The maximum capacitance for FIG. 3c can be expressed as

Cₘₐₓ=[(CA+CB)·(CsA+CsB)]/[(CA·CB)(CsA+CsB)]

and it is reasonable to make a simplification CA=CB and CsA=CsB (a design choice) after which the total capacitance reduces to

½(CA+CsA)

Consider the relative motion of Mf as it disengages from a geometric projection onto Sp1 and the capacitance CA diminishes while CB remains constant until the capacitive disengagement is complete and the series relationship of CA and CB (first term of the above expression) vanishes. The capacity of the (idealized) network is now reduced to stray capacity Cₛ₁ between the terminal points. For notational convenience assume that Cs₁ of FIG. 3b is the same as CsA and CsB. In comparison with prior art Cmin, this provides for a minimum capacitance that is ¼ of that of the prior art and the resulting RF impedance is four times as great for the present capacitor unit.

A capacitance similar to that shown in FIG. 1 a has been tested in comparison with a commercially available prior art component (Voltronics #8036, available from Voltronics Corp., Denville, N.J.). Representative capacitor units for test were constructed following the design of FIG. 1a and were constructed from quartz tubes having dimensions in inches:

outertube:o.d.=0.190;i.d.=0.170 length 2.4

innertube:o.d.=0.164;i.d.=0.144 length=2.4

Cmax=1.8 pf Cmin<˜0.01 pf axial displacement=0.7

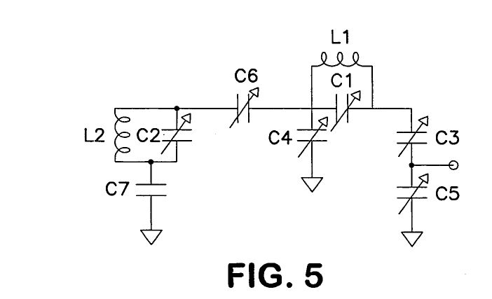

Measurements were made for comparison of representative prior art and the present capacitor unit incorporated in an NMR probe for which resonances corresponding to both ¹H and ¹⁹F were observed to obtain observations of performance at respective frequencies. The test circuit is shown at FIG. 5 and couples a first sub-circuit L1-C1 with a second sub-circuit L2-C2. The prior art and present capacitor units were alternately incorporated to tune and match (C3 and C5) a ¹H resonant circuit at 600 MHz. Additionally, the present (FIG. 1 a embodiment) capacitor unit was employed to couple in both sets of measurements between the ¹H resonant circuit and a second (¹⁹F) resonant circuit to produce a state of coupling (maximum value C6) or isolation (minimum value C6) therebetween. An extremely high isolating impedance is furnished by the capability of the present capacitor to reach a capacitance approaching a value of zero without additional serial chip capacitors with attendant solder joints. The coupling/isolation function permits the concurrent observation of concurrent resonances (sub-circuits coupled) or the single resonance (sub-circuits isolated). US application entitled “Multi-Functional NMR Probe” by Albert P. Zens and James P. Finnigan, describes the details of this concurrent resonance/single resonance circuit. The relevant corresponding measurement of the prior art and present capacitors is presented in table 1 summarizing response of the test circuit (figure) in actual NMR performance comparing the present capacitor units with prior art capacitors. That is, the embodiment of FIG. 1 is substituted in the circuit of FIG. 5 for the tune and match capacitors C3, C4 and CS for comparison against the same circuit containing the prior art capacitors at those positions and having the same nominal specifications. Two modes of operation are examined: as denominated “dual”, the circuit is concurrently sensitive to both the ¹H and ¹⁹F resonances at 600 MHz and 564.56 MHz respectively. The “solo” mode is activated by isolation of the sub-circuit L2-C2 through reduction of C6 to a value approaching zero capacitance. Component C6, identical with capacitors C3 through C5, remains unchanged in these tests.

TABLE 1
Bench tests

| | capacitors | | | | | |
|---|---|---|---|---|---|---|
| | in | | | | field | |
| Resonance | principal | | f | | displacement | E_{rBench}* |
| Mode | subcircuit | Nucleus | [MHz] | Q | test [%] | [%] |
| dual | prior art | ¹H | 600.0 | 227 | 0.433% | 100.0% |
| | | ¹⁹F | 564.6 | 189 | 0.248% | 100.0% |
| | present | ¹H | 600.0 | 286 | 0.433% | 79.4% |
| | | ¹⁹F | 564.6 | 244 | 0.283% | 67.8% |
| solo | prior art | ¹H | 600.0 | 222 | 0.733% | 60.4% |
| | present | ¹H | 600.0 | 257 | 0.750% | 51.0% |

*E_{rBench} is proportional to the power required to achieve constant field inside the NMR coil.

A comparison of the values for ErBench of the capacitors C3,C4 and C5 of prior art with the present work is interpreted as demonstrating that much less power is required to obtain the same field within the NMR coil.

TABLE 2
NMR tests

| | | | | | Power | |
|---|---|---|---|---|---|---|
| | capacitors | | | | needed for | |
| | in principal | | f | pw₉₀@1 W | 1 mT B₁ field | E_{rNMR} |
| Resonance Mode | subcircuit | Nucleus | [MHz] | [μs] | [W] | [%] |
| dual | prior art | ¹H | 600.0 | 46.8 | 63.3 | 100.0% |
| | | ¹⁹F | 564.6 | 56.8 | 82.7 | 100.0% |
| | present | ¹H | 600.0 | 42.0 | 51.0 | 80.5% |
| | work | ¹⁹F | 564.6 | 33.5 | 50.8 | 61.4% |

*NMR test data. E_{rNMR} is proportional to the power required to achieve constant field inside the NMR coil.

The parameter PW-90° is the length of the pulse (at constant specified RF power) required to rotate the resonating nuclear spins 90° and this may be taken as a figure of merit for the efficiency of the circuit and here measures the comparison of the capacitors of prior art to components corresponding to the present work. In the test circuit of FIG. 5 the principal resonant sub-circuit L1-C1 couples the resonant energy stored therein to a physical sample surrounded by the coil L1. In any real circuit the leads from L1 through C4, C3 and C5 contribute inductance and the capacitors C4, C3 and C5 contribute additional stray capacitance limiting the value of the effective capacitance. The resonant energy is thus distributed, even as these circuit parameters are distributed. The capacitor unit of the present work reduces the effect of stray capacitance and the resonant energy developed in the circuit is more nearly concentrated within the physical space of the coil L1 and this is shown by the more efficient energy transfer to the resonant nuclear spin system within the coil L1. The capacitors of the embodiment of FIG. 1a contribute greater efficiency as measured by the PW-90° standard in comparison with capacitors of the prior art, e.g., shorter pulses are required for the same nuclear spin rotation.

The capacitors C3, C4 and C5 of the test circuit of FIG. 5 are general application variable capacitors for which the dynamic range and linear response of the present implementation is superior. The capacitor C6 represents a reactive switch function (present in both sets of measurements of table 1). This function emphasizes the dynamic range and achievable ultra low capacitance. An unusual degree of isolation between resonant sub-circuits is afforded by the minimum capacitance state of the present capacitor unit in the role of capacitance C6. This property is roughly quantifiable through comparison of modeling calculations of the circuit of FIG. 5 with the observations summarized in table 1.

The test circuit of FIG. 5, has been modeled (using TOUCHSTONE FOR WINDOWS®, version 2.100.200) to explore the behavior of the circuit over a range of component values for C6 as constrained by actual values for other components. The model yields a value for the minimum capacitance of C6 to produce observed relative efficiency of the solo mode as observed to an optimized reference circuit for which the components C2, C6, C7, and L2 are deleted. A capacitance of 0.004 pf results from the model. The design value, considering geometry alone is about 0.005 pf. Given the tolerances of circuit component values, stray reactances and the like, the agreement with observation is quite satisfactory.

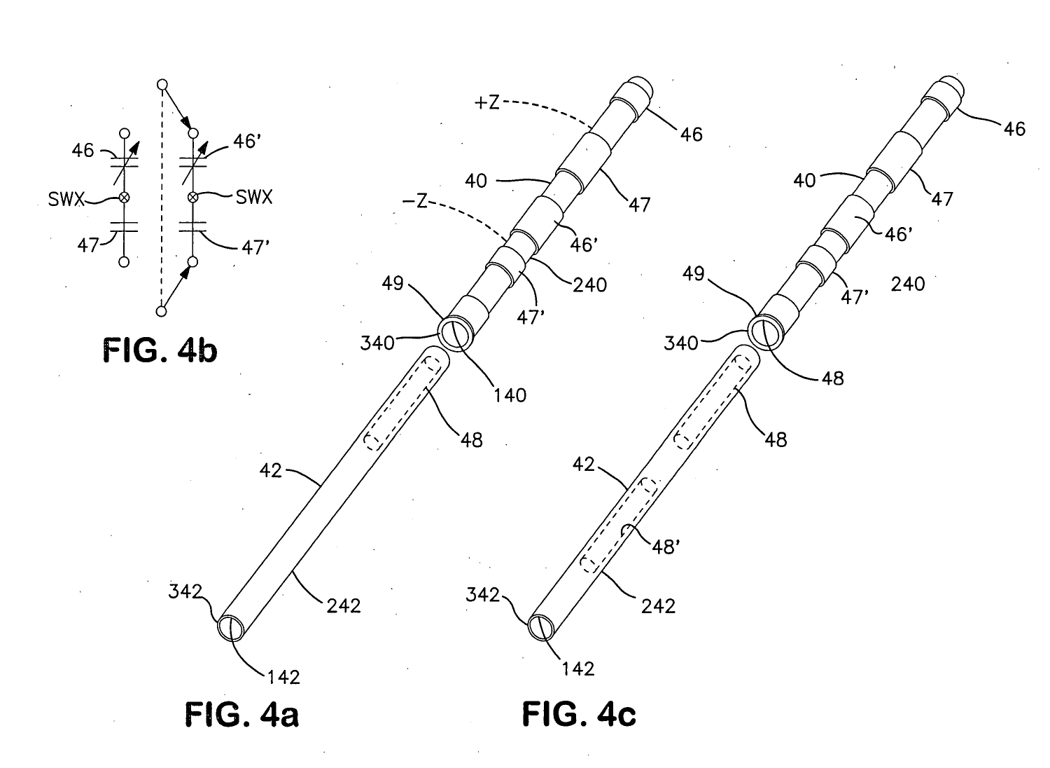

The maximum capacitance of C6 is determined by design with the result that the capacitor unit exhibits a dynamic range of about two orders of magnitude. FIG. 4a represents an embodiment employing ganging of two separate capacitor units employing a single common stator wherein the floating movable conductive member (48) is dimensioned to overlay the projection of only one pair of stators comprising one such capacitor unit at a time in alternative positions centered at +z and −z. The equivalent diagram at FIG. 4b treats the alternative ranges of positions of floating movable member 48 to constitute a two state selectable reactive switch. The switch symbol SWX serves to emphasize the functional status of the present capacitor unit as the floating conductor moves beyond the minimum capacity of one of the constituent capacitors of a capacitor unit. This arrangement differs from the embodiment of FIG. 2a in the structural sense that FIG. 2a has no intermediate common stator for different capacitor units sequentially formed with floating conductor 48. In the functional sense, the embodiment of FIG. 4a provides independence in the selected capacitor units and with appropriate choice of dimensions, can easily provide a neutral, or floating state where neither of the capacitor units is selected.

FIG. 4c illustrates a variation in the embodiment of FIG. 4a through a simple ganging arrangement. A second floating conductor 48′ is disposed on the tube 42 to effect the same series relationship to stators 46′ and 47′ as is found in the system of stators 46-47 with floating conductor 48. In this way simultaneous (ganged) actuation of independently defined capacitor units is obtained.

Although this invention has been described with reference to particular embodiments and examples, other modifications and variations will occur to those skilled in the art in view of the above teachings. The capacitor unit arrangement disclosed herein is not limited to a particular geometry such as coaxial tubes, and planar substrates and conductors are a straightforward variation of the above described capacitor units. It should be understood that, within the scope of the appended claims, this invention may be practiced otherwise than as specifically described.

What is claimed is:

1. An adjustable capacitor unit comprising:
a) A first stator disposed along an axis of adjustment and having axial extension z1;
b) A second stator disposed along said axis and having axial extension of z2, said first and second stators in fixed relationship and displaced by a gap g,
c) a first electrically floating conductor along a second axis parallel to said first axis and displaced therefrom by a distance t, said floating conductor having an axial extent of substantially z1+z2+g, said floating member capable of displacement along said second axis over a range from fully occupying the projection of first and second stators to a displacement fully removed from such projection; and
d) at least one dielectric material disposed between said floating conductor and said first and second stators.

2. The adjustable capacitor of claim 1, wherein said first and second stators comprise conducting bands supported on a first substrate and said floating conductor is supported on a second substrate.

3. The adjustable capacitor of claim 2, wherein the one said substrate comprises an outer tube and the other said substrate comprises a cylinder coaxially disposed within said outer tube and wherein said substrates and conductors supported thereon are dimensioned to present at least a slip fit.

4. The adjustable capacitor of claim 3, wherein said cylinder is a tube having an inner wall and an outer wall comprising an inner tube.

5. The adjustable capacitor of claim 4, wherein the first and second stators are supported on an outer surface of the outer tube.

6. The adjustable capacitor of claim 4, wherein the electrically floating conductor is supported on aninner surface of the inner tube.

7. The adjustable capacitor of claim 4, wherein the electrically floating conductor is supported on the outer surface of the inner tube.

8. The adjustable capacitor of claim 1, comprising a third stator supported on a common surface with said first and second stators and disposed axially therebetween.

9. The adjustable capacitor of claim 1, further comprising third and fourth stators on a common surface with said first and second stators and displaced axially therefrom.

10. The adjustable capacitor of claim 9, comprising a second electrically floating conductor supported in common on the same substrate as the first electrically floating conductor.

11. The adjustable capacitor of claim 10, wherein said first and second floating conductors are supported on a common surface of said same substrate.

12. The adjustable capacitor of claim 10, wherein said first and second floating conductors are supported on opposite surfaces of said same substrate.

13. The method of providing selective reactive isolation or reactive coupling between arbitrary circuit elements comprising:
providing a first stator and a second stator and a floating conductor;
forming a first capacitive coupling between a portion of an electrically floating conductor and a first stator comprising a maximum and forming a second capacitive coupling between another portion of said floating conductor and said second stator; and
displacing said floating conductor along a trajectory in a first direction such that for a selected displacement, said second capacitive coupling remains constant while said first capacitive coupling approaches substantially null capacitance.

14. The method of claim 13, comprising the step of continuing said displacement to isolate said circuit elements.

15. The method of claim 13, comprising the step of
displacing said floating conductor along a trajectory in a direction thereof opposite to said first direction, whereby said circuit elements are coupled.
